(19) United States
(12) Patent Application Publication
(10) Pub. No.: US 2025/0299573 A1
(43) Pub. Date: Sep. 25, 2025

(54) Emergency Vehicle Detection and Alert System

(71) Applicant: Cesar Villicana, Hobart, IN (US)

(72) Inventor: Cesar Villicana, Hobart, IN (US)

(21) Appl. No.: 19/071,991

(22) Filed: Mar. 6, 2025

Related U.S. Application Data
(60) Provisional application No. 63/569,417, filed on Mar. 25, 2024.

(51) Int. Cl. G08G 1/0965; B60W 50/14; G08G 1/0967

(52) U.S. Cl. CPC G08G 1/0965; B60W 50/14; G08G 1/096725; B60W 2050/143; B60W 2050/146; B60W 2420/54; B60W 2556/50

(57) ABSTRACT

The present invention is an emergency vehicle alert system designed to enhance road safety by notifying drivers of approaching emergency vehicles such as ambulances, police cruisers, and fire trucks. The system includes a software application integrated into a vehicle's dashboard and is equipped with a database of emergency siren sound profiles and a signal processing module to analyze ambient sound and identify emergency vehicle sirens. The system captures ambient sound using built-in microphones or sensors, filters irrelevant noise, and generates alerts such as visual notifications on the dashboard, audible alerts, and/or text-based messages. Additionally, the system mutes the vehicle's audio system during alerts. The invention also includes an aftermarket cigarette lighter plug-in variant with embedded detection and alert capabilities.

### CROSS-REFERENCE TO RELATED APPLICATION

The present application claims priority to, and the benefit of, U.S. Provisional Application No. 63/569,417 which was filed on Mar. 25, 2024, and is incorporated herein by reference in its entirety.

### FIELD OF THE INVENTION

The present invention generally relates to vehicle safety systems designed to enhance road safety and driver awareness. More specifically, the invention relates to an emergency vehicle alert system configured to detect and notify drivers of approaching emergency vehicles such as ambulances, police cruisers, and fire trucks. The system integrates with a vehicle's dashboard and includes a software application that utilizes a database of emergency siren profiles and analyzes ambient sound captured by built-in microphones or external audio sensors. Upon detecting an emergency vehicle siren, the system generates visual, audible, and location-based alerts for the driver. Accordingly, the present disclosure makes specific reference thereto. Nonetheless, it is to be appreciated that aspects of the present invention are also equally applicable to other like applications, devices, and methods of manufacture.

### BACKGROUND

By way of background, emergency vehicles such as ambulances, police cruisers, and fire trucks are critical to saving lives and responding effectively to emergencies. Further, emergency vehicles need a clear and timely pathway for providing an effective response. However, one of the biggest challenges for emergency vehicles is navigating through traffic when other drivers are unaware of their presence.

Conventional measures, such as relying solely on the sirens or lights of emergency vehicles are used for driver response, however, are often insufficient in ensuring timely driver response. Drivers with loud music playing or those engaged in conversations or using their phones might not hear sirens or see flashing lights. Heavy traffic can further mask the sound of sirens, especially for vehicles further away. Blind spots, large vehicles blocking the view, or poor weather conditions can obstruct drivers' vision of emergency vehicles. Some drivers are inattentive or unaware of their surroundings, failing to notice the emergency vehicle's signals. Accordingly, emergency vehicles can lose precious minutes trying to navigate through congested traffic, potentially hindering their ability to provide timely assistance. Delays caused by traffic congestion can reduce the effectiveness of emergency services, potentially impacting patient outcomes in medical emergencies or hindering firefighting efforts. Consequently, there is a pressing need for a system that can reliably detect the presence of nearby emergency vehicles and provide drivers with clear, unmissable alerts, thereby promoting road safety and facilitating faster emergency response.

Therefore, there exists a long-felt need in the art for a system that addresses the challenges drivers face in promptly reacting to approaching emergency vehicles. Specifically, there is a long-felt need for a device capable of alerting drivers who fail to hear emergency vehicle sirens due to distractions, environmental noise, or vehicle soundproofing. Additionally, there is a need for a system that not only notifies drivers of nearby emergency vehicles but can be integrated with existing vehicle systems. Furthermore, there exists a long-felt need for a solution that minimizes delays caused by drivers who do not pull over in time, impeding the passage of emergency responders. Also, there is a long-felt need in the art for a safety system that sounds an audible alert when the vehicle is nearby, so the driver has enough time to safely pull the vehicle to the side of the road. Finally, there is a need for a versatile and user-friendly system that can be installed in both new and existing vehicles and improves roadway safety regarding emergency service vehicles.

The subject matter disclosed and claimed herein, in one embodiment, comprises an emergency vehicle alert system designed to detect the presence of approaching emergency vehicles and notify drivers through a combination of visual, audible, and location-based alerts. The system includes a software application integrated into a vehicle's dashboard that utilizes a database of emergency vehicle siren profiles to process and analyze ambient sound captured by built-in microphones or external sensors. The application receives ambient sound, and the system generates alerts such as a visual indicator on the dashboard, an audible warning, and optional GPS-based directional guidance. Additionally, the system is configured to mute the vehicle's audio system during an alert for the driver's attention on the warning. The system is available in multiple embodiments, including a cigarette lighter plug-in for aftermarket use.

In this manner, the emergency vehicle alert system of the present invention fulfills the aforementioned needs by offering an integrated, automated solution to improve driver responsiveness to emergency vehicles. The system incorporates advanced signal processing and database matching to ensure reliable siren detection, even in noisy environments. Moreover, the system is compatible with Advanced Driver-Assistance Systems (ADAS), enabling features such as lane-keeping assistance to deactivate automatically (i.e., autonomously) during an alert. The system is available in multiple embodiments, including a cigarette lighter plug-in for aftermarket use, making it accessible to a wide range of drivers. The system ensures that a driver is fully aware that an ambulance, police cruiser, and other emergency service vehicles are approaching and to pull over.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for alerting a driver to the presence of an approaching emergency vehicle. The method includes capturing ambient sound in real time using one or more microphones integrated into a vehicle, processing the captured ambient sound to filter out irrelevant noise and isolate sound patterns associated with emergency vehicle sirens, comparing the isolated sound patterns with pre-stored emergency vehicle siren profiles in a database, upon identifying a match between the isolated sound patterns and the pre-stored profiles, generating one or more alerts for the driver, wherein the alerts include at least one of a visual alert displayed on a dashboard, an audible alert emitted through the vehicle's sound system, and a text-based notification displayed on a user interface.

In another aspect, the method includes muting the vehicle's audio system during the generation of the alerts and unmuting the vehicle's audio system and clearing the visual and text-based notifications when the emergency vehicle is no longer in proximity to the vehicle.

In one embodiment, a method for enhancing driver awareness of nearby emergency vehicles using a software application integrated into a vehicle is disclosed. The method includes initializing the software application during vehicle startup, receiving ambient sound through at least one of a built-in microphone and an external audio sensor of the vehicle, processing the ambient sound to distinguish emergency vehicle sirens from background noise, determining the relative location of the emergency vehicle using a GPS module of the vehicle, generating a visual notification on a dashboard display indicating the relative location of the emergency vehicle, activating an advanced driver-assistance system (ADAS) of the vehicle to initiate lane-keeping or other safety features in response to detecting the emergency vehicle, and deactivating the visual notification and ADAS features once the emergency vehicle is no longer within proximity to the vehicle.

In yet another aspect, an emergency vehicle alert system for a vehicle is disclosed. The system includes a software application integrated into a dashboard of the vehicle, the software application includes a database storing emergency vehicle siren sound profiles, a signal processing module configured to analyze ambient sound and distinguish emergency vehicle sirens from background noise by comparing captured sound patterns with the stored profiles, at least one microphone or audio sensor is configured to capture ambient sound around the vehicle and provide input to the software application, a visual alert identifier is disposed on the dashboard for notifying the driver when an emergency vehicle is detected, a control module is configured to mute the vehicle's sound system upon detection of an emergency vehicle siren, provide visual and audible alerts to the driver, and unmute the sound system and deactivate the alerts when the emergency vehicle is no longer in proximity.

In still another embodiment, an aftermarket emergency vehicle detection device for use in a vehicle is disclosed. The device includes a cigarette lighter plug-in configured to receive power from a vehicle's cigarette lighter port, a microphone embedded within the plug-in to capture ambient sound, an audio processing unit integrated into the plug-in, the audio processing unit configured to process captured sound to identify sound patterns associated with emergency vehicle sirens and compare the identified patterns with pre-stored profiles of emergency sirens. An audible alert speaker is embedded within the plug-in for providing audible alerts to the driver. A Bluetooth transmitter is configured to transmit alerts to the vehicle's dashboard or infotainment system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of emergency vehicle detection and alert system of the present invention in accordance with the disclosed architecture;

FIG. 2 illustrates a perspective view showing the emergency vehicle alert system of the present invention being in use in a vehicle in accordance with one embodiment of the present invention;

FIG. 3 illustrates an exemplary user interface provided by the emergency vehicle alert system of the present invention in accordance with the disclosed structure;

FIG. 4 illustrates the emergency vehicle alert system in the form of a cigarette lighter plug-in in accordance with one embodiment of the present invention;

FIG. 5 illustrates a flow chart depicting a process of alerting drivers about nearby emergency vehicles in accordance with the disclosed architecture; and

FIG. 6 illustrates a schematic view of another embodiment of the emergency vehicle detection system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that addresses the challenges drivers face in promptly reacting to approaching emergency vehicles. Specifically, there is a long-felt need for a device capable of alerting drivers who fail to hear emergency vehicle sirens due to distractions, environmental noise, or vehicle soundproofing. Additionally, there is a need for a system that not only notifies drivers of nearby emergency vehicles but can be integrated with existing vehicle systems. Furthermore, there exists a long-felt need for a solution that minimizes delays caused by drivers who do not pull over in time, impeding the passage of emergency responders. Also, there is a long-felt need in the art for a safety system that sounds an audible alert when the vehicle is nearby, so the driver has enough time to safely pull the vehicle to the side of the road. Finally, there is a need for a versatile and user-friendly system that can be installed in both new and existing vehicles and improves roadway safety regarding emergency service vehicles.

The present invention, in one exemplary embodiment, is an emergency vehicle alert system for a vehicle. The system includes a software application integrated into a dashboard of the vehicle, the software application includes a database storing emergency vehicle siren sound profiles, a signal processing module configured to analyze ambient sound and distinguish emergency vehicle sirens from background noise by comparing captured sound patterns with the stored profiles, at least one microphone or audio sensor is configured to capture ambient sound around the vehicle and provide input to the software application, a visual alert identifier is disposed on the dashboard for notifying the driver when an emergency vehicle is detected, a control module is configured to mute the vehicle's sound system upon detection of an emergency vehicle siren, provide visual and audible alerts to the driver, and unmute the sound system and deactivate the alerts when the emergency vehicle is no longer in proximity.

Reference will now be made in detail to the present preferred embodiments of the invention, examples of which are illustrated in the accompanying drawings. Wherever possible, the same reference numerals are used in the drawings and the description to refer to the same or like parts.

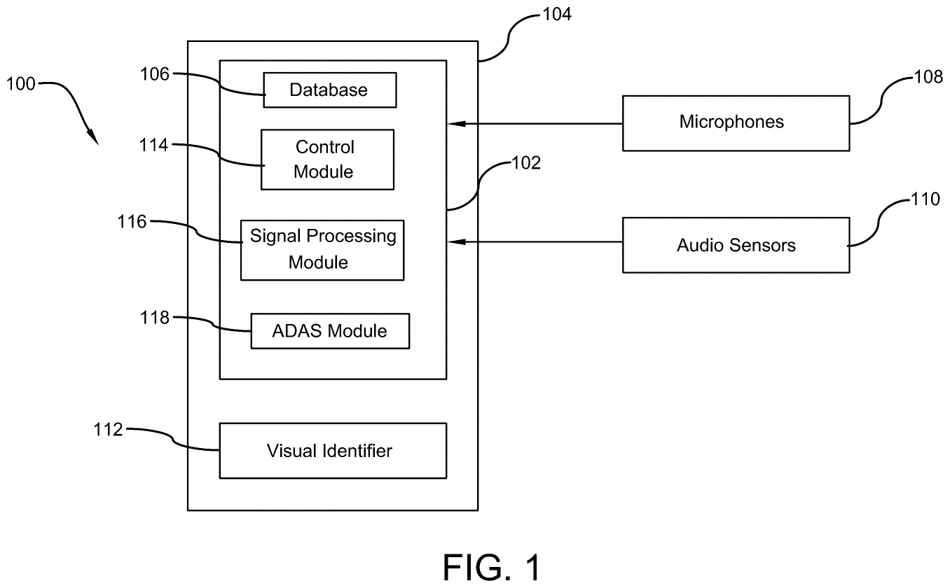

Referring initially to the drawings, FIG. 1 illustrates a schematic view of emergency vehicle detection and alert system of the present invention in accordance with the disclosed architecture. The emergency vehicle alert system 100 of the present invention is designed to enhance road safety by alerting drivers to the presence of approaching emergency vehicles such as ambulances, police cruisers, or fire trucks. More specifically, the system 100 includes a software application/system 102 installed in a dashboard 104 of a vehicle. The software system 102 is configured to integrate with the dashboard and sound system of the vehicle. The software system 102 includes a database 106 which stores a plurality of emergency vehicles sound profiles, enabling the application 102 to compare and match incoming sounds to known patterns of emergency vehicle sirens.

The software application 102 is coupled to built-in microphones 108 or external audio sensors 110 of the vehicle which capture the ambient sounds. The software application 102 receives the ambient sound from the microphones 108 or sensors 110 to compare with the stores profiles in the database 106. A visual alert identifier 112 is disposed in the dashboard 104 of the vehicle for providing a visual notification to the driver when an emergency vehicle is detected nearby the vehicle. Preferably, the visual alert identifier 112 is in the form of an LED button.

The system 100 also includes a control module 114 which can be in the form of a hardware and in some embodiments, can be embedded in the software application 102. The control module 114 is configured to mute the sound system of the vehicle when the system 100 detects an emergency vehicle siren. The software system 102 uses a signal processing module 116 to distinguish emergency vehicle sirens from other road noise when noise is received from the microphones 108 and sensors 110.

The software application 102 is configured to provide a user interface for displaying location information of the approaching emergency vehicle as described later in the disclosure. The application 102 may use GPS module of the vehicle to determine relative position of the vehicle relation to the approaching emergency vehicle. The software application 102 is also adapted to be coupled to Advanced Driver-Assistance Systems (ADAS) module 118 of the vehicle to automatically (i.e., autonomously) deactivate ADAS features such as lane keeping assistant upon detection of an emergency vehicle.

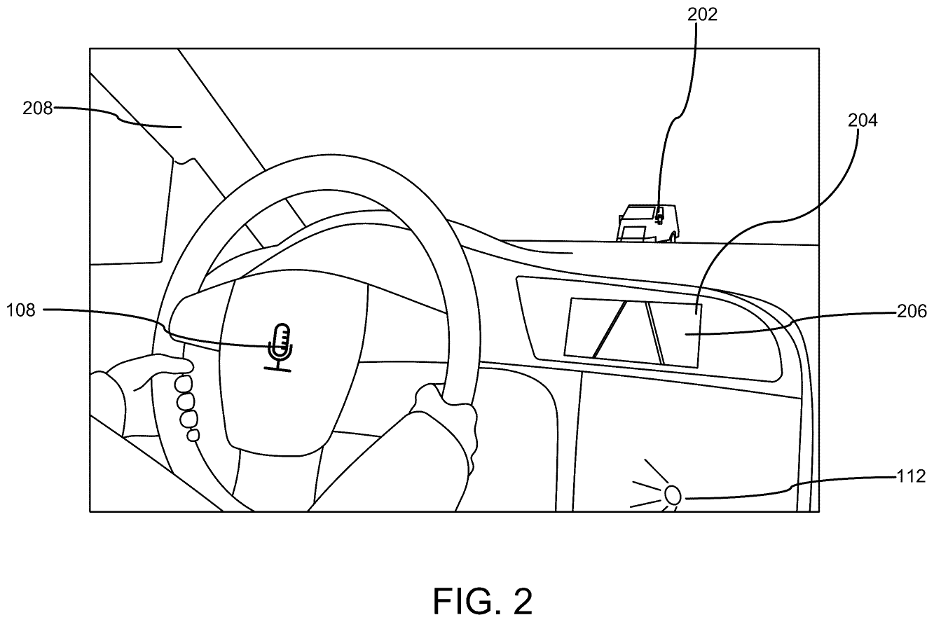

FIG. 2 illustrates a perspective view showing the emergency vehicle alert system of the present invention being in use in a vehicle in accordance with one embodiment of the present invention. The software application 102 when receiving ambient sound through the microphone 108 (or audio sensor 110, not shown in FIG. 2), detects a nearby emergency vehicle 202 and provides a user interface 204 in the dashboard display 206 of the vehicle 208. The user interface 204 displays the relative location of the vehicle 208 and the emergency vehicle 202, helping the driver to move the vehicle from the path of, or way of, the emergency vehicle 202.

Upon detection of the emergency vehicle 202, the visual identifier 112 is automatically (i.e., autonomously) activated by the system 100 for providing a visual alert to the driver. In some embodiments, an audible notification such as “Emergency Vehicle Nearby” or any other similar notification may be automatically (i.e., autonomously) activated using speaker of the dashboard 104.

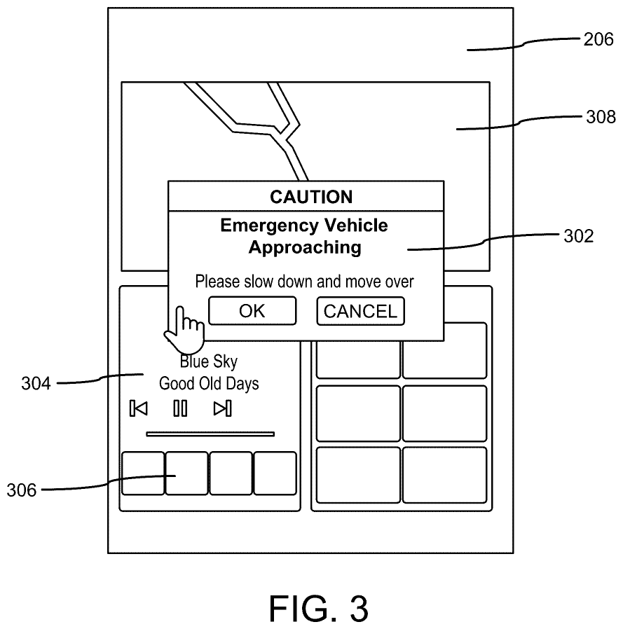

FIG. 3 illustrates an exemplary user interface provided by the emergency vehicle alert system of the present invention in accordance with the disclosed structure. In the present embodiment, a notification 302 is displayed on the dashboard display 206 showing that an emergency vehicle is detected by the system 100 and is approaching towards the vehicle in which the system 100 is installed.

Further, the application 102 mutes the vehicle's sound system and mutes the music 304, calls 306, and more. Further, a digital map 308 (as illustrated in FIG. 2 as well) is displayed for providing exact position of the emergency vehicle.

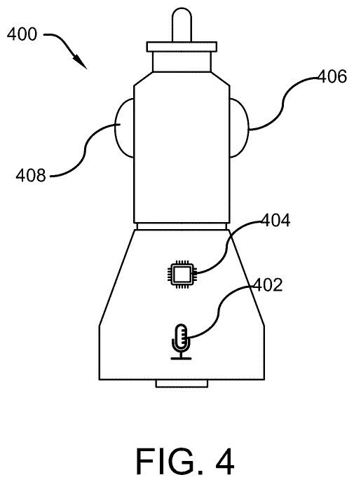

FIG. 4 illustrates the emergency vehicle alert system in the form of a cigarette lighter plug-in in accordance with one embodiment of the present invention. The system 100 of the present invention can be integrated into a vehicle during manufacturing of the vehicle via the software application as described above. To use the system 100 as an aftermarket accessory, the system 100 is designed as a cigarette lighter plug-in 400. The cigarette lighter plug-in 400 is compatible with conventional lighter port of vehicles. The cigarette lighter plug-in 400 includes a microphone 402 to capture ambient sound around the vehicle, including emergency vehicle sirens. An audio processing unit 404 embedded in the plug-in 400 processes the audio signals captured by the microphone 402 to identify emergency sirens and may utilize sound recognition algorithms and filters to isolate siren patterns from background noise. An embedded siren detection algorithm identifies specific audio frequencies and patterns associated with emergency sirens and an audible alert speaker 406 emits a clear and loud alert sound to notify the driver when an emergency vehicle is detected.

The cigarette lighter plug-in 400 includes a Bluetooth transmitter 408 for providing communication with the dashboard or infotainment system of a vehicle. The transmitter 408 can transmit alerts directly to the vehicle's audio system for providing alerts to the driver. The plug-in 400 receives electric power from cigarette lighter port (12V DC) of a vehicle.

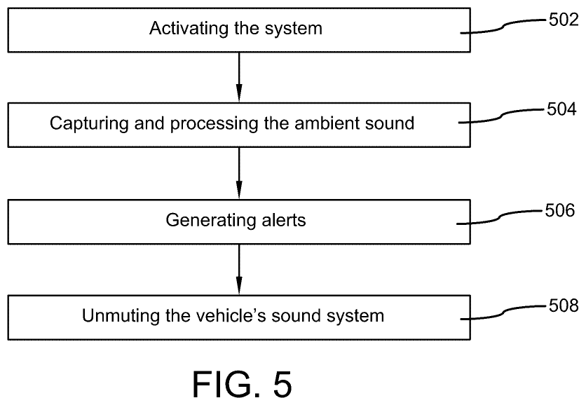

FIG. 5 illustrates a flow chart depicting a process of alerting drivers about nearby emergency vehicles in accordance with the disclosed architecture. Initially, the system 100 is activated for enabling the drivers to be alerted about nearby emergency vehicles (Step 502). The cigarette lighter plug-in 400 can be plugged into the vehicle's cigarette lighter port and the software 102 can be initialized during vehicle startup. Then, the integrated microphone captures ambient sound in real time and the captured sound is processed to filter out irrelevant noise such as wind, music, or another vehicle sounds (Step 504). Thereafter, the system verifies detected sounds to minimize false positives and upon detection of a siren, one or more alerts (including but not limited to visual, audible, and text) are generated (Step 506). The system continues to track the siren sound to determine when the emergency vehicle has passed or is no longer within proximity and once the emergency vehicle is out of range, the system may unmute sound system of vehicle and visual notifications are cleared from the dashboard display (Step 508).

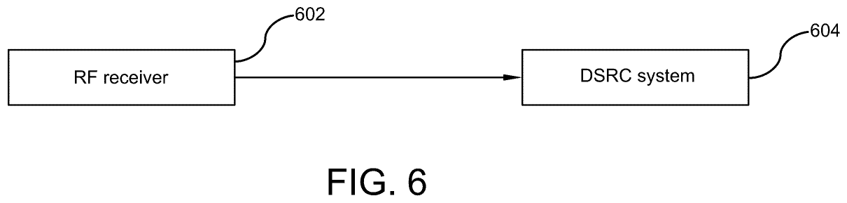

FIG. 6 illustrates a schematic view of another embodiment of the emergency vehicle detection and alert system of the present invention in accordance with the disclosed structure. As illustrated, the emergency vehicle notification system 600 includes a Radio Frequency (RF) receiver 602 which is configured to receive RF signals transmitted by emergency vehicles to detect nearby emergency vehicles. The present embodiment is useful for systems, where emergency vehicles use Dedicated Short-Range Communication (DSRC) system 604 to transmit signals to nearby vehicles or infrastructure. The RF receiver 602 may be configured to receive RF signals in the frequency band ranging from 5 GHz to about 6 GHz. Based upon detection of RF signals, the system 600 may provide alerts to the driver and stop sound system of the vehicle. It should be noted that all the functionality and components of system 100 are included in the system 600 of the present embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency vehicle detection and alert system”, “emergency vehicle alert system”, “emergency vehicle notification system”, and “system” are interchangeable and refer to the emergency vehicle detection and alert system 100 of the present invention.

Notwithstanding the forgoing, the emergency vehicle detection and alert system 100 of the present invention can be of any suitable configuration as is known in the art without affecting the overall concept of the invention, provided that it accomplishes the above stated objectives. One of ordinary skill in the art will appreciate that the emergency vehicle detection and alert system 100 as shown in the FIGS. are for illustrative purposes only, and that many other configurations of the emergency vehicle detection and alert system 100 are well within the scope of the present disclosure. Although the dimensions of the emergency vehicle detection and alert system 100 are important design parameters for user convenience, the emergency vehicle detection and alert system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An alert software application system for a vehicle dashboard comprising:
a software application system;
a database;
a plurality of emergency vehicle sound profiles;
a plurality of audio sensors for capturing ambient sounds;
an alert identifier;
a control module; and
a vehicle sound system;
wherein said database stores said plurality of emergency vehicle sound profiles;
wherein said software application system coupled to said plurality of audio sensors;
wherein said software application system matches incoming sounds from said plurality of audio sensors to known patterns of said plurality of emergency vehicle sound profiles; and
further wherein said alert identifier disposed in a dashboard of the vehicle for providing a visual notification to a driver when an emergency vehicle is detected nearby the vehicle.

2. The alert software application system for a vehicle dashboard of claim 1, wherein said alert identifier is selected from the group consisting of an audio alert and a visual alert.

3. The alert software application system for a vehicle dashboard of claim 1, wherein said control module mutes a sound system of the vehicle when said application software system detects emergency vehicle sirens.

4. The alert software application system for a vehicle dashboard of claim 3, wherein said signal processing module distinguishes the emergency vehicle sirens from other road noises when noises are received from said plurality of audio sensors.

5. The alert software application system for a vehicle dashboard of claim 4, wherein said software application system having a user interface for displaying a location of an approaching emergency vehicle.

6. The alert software application system for a vehicle dashboard of claim 5, wherein said software application system having a GPS module of the vehicle to determine a position of the vehicle relative to the approaching emergency vehicle.

7. The alert software application system for a vehicle of claim 6, wherein said software application system coupled to the Advanced Driver-Assistance Systems (ADAS) module of the vehicle to autonomously deactivate said ADAS upon detection of an emergency vehicle siren.

8. A method of alerting a driver to an emergency vehicle, the method comprising the steps of:
providing a software application system, a database, a plurality of emergency vehicle sound profiles, a plurality of audio sensors for capturing ambient sounds, an alert identifier, a control module, and a vehicle sound system, wherein said database stores said plurality of emergency vehicle sound profiles;
coupling said software application system to said plurality of audio sensors;
matching incoming sounds from said plurality of audio sensors to known patterns of said plurality of emergency vehicle sound profiles; and
providing a visual notification to a driver when an emergency vehicle is detected nearby the vehicle with said alert identifier disposed in a dashboard.

9. The method of alerting a driver to an emergency vehicle of claim 8, wherein said alert identifier is selected from the group consisting of an audio alert and a visual alert.

10. The method of alerting a driver to an emergency vehicle of claim 8 further comprising the step of muting a sound system of the vehicle with said control module when said application software system detects emergency vehicle sirens.

11. The method of alerting a driver to an emergency vehicle of claim 10, wherein said signal processing module distinguishes the emergency vehicle sirens from other road noises when noises are received from said plurality of audio sensors.

12. The method of alerting a driver to an emergency vehicle of claim 11, wherein said software application system having a user interface for displaying a location of an approaching emergency vehicle.

13. The method of alerting a driver to an emergency vehicle of claim 12, wherein said software application system having a GPS module of the vehicle to determine a position of the vehicle relative to the approaching emergency vehicle.

14. The method of alerting a driver to an emergency vehicle of claim 13, wherein said software application system coupled to the Advanced Driver-Assistance Systems (ADAS) module of the vehicle to autonomously deactivate said ADAS upon detection of an emergency vehicle siren.

15. A method of alerting a driver to an emergency vehicle, the method comprising the steps of:
providing a software application system, a database, a plurality of emergency vehicle sound profiles, a plurality of audio sensors for capturing ambient sounds, an alert identifier, a control module, and a vehicle sound system, wherein said database stores said plurality of emergency vehicle sound profiles;
coupling said software application system to said plurality of audio sensors;
matching incoming sounds from said plurality of audio sensors to known patterns of said plurality of emergency vehicle sound profiles;
providing a visual notification to a driver when an emergency vehicle is detected nearby the vehicle with said alert identifier disposed in a dashboard;
muting a sound system of the vehicle with said control module when said application software system detects emergency vehicle sirens; and
unmuting said sound system of the vehicle when the emergency vehicle is no longer within proximity to the vehicle.

16. The method of alerting a driver to an emergency vehicle of claim 15, wherein said alert identifier is selected from the group consisting of an audio alert and a visual alert.

17. The method of alerting a driver to an emergency vehicle of claim 16, wherein said signal processing module distinguishes the emergency vehicle sirens from other road noises when noises are received from said plurality of audio sensors.

18. The method of alerting a driver to an emergency vehicle of claim 17, wherein said software application system having a user interface for displaying a location of an approaching emergency vehicle.

19. The method of alerting a driver to an emergency vehicle of claim 18, wherein said software application system having a GPS module of the vehicle to determine a position of the vehicle relative to the approaching emergency vehicle.

20. The method of alerting a driver to an emergency vehicle of claim 19, wherein said software application system coupled to the Advanced Driver-Assistance Systems (ADAS) module of the vehicle to autonomously deactivate said ADAS upon detection of an emergency vehicle siren.
